(19) United States
(12) Patent Application Publication
(10) Pub. No.: US 2025/0041877 A1
(43) Pub. Date: Feb. 6, 2025

(54) SEPARATOR AND METHOD FOR PURIFYING A LIQUID-SOLID MIXTURE

(71) Applicant: GEA WESTFALIA SEPARATOR GROUP GMBH, Oelde (DE)

(72) Inventors: Andree FLACH, Hannover (DE); Detlef ULLMANN, Oelde (DE); Sven HEYMANN, Sangerhausen (DE); Christian STRAKE, Oelde (DE)

(21) Appl. No.: 18/720,175

(22) PCT Filed: Dec. 8, 2022
(86) PCT No.: PCT/EP2022/085075

§ 371 Date: Jun. 14, 2024

(30) Foreign Application Priority Data
Dec. 15, 2021 (DE) 10 2021 133 336.9

(51) Int. Cl. B04B 11/06; B01D 21/26; B04B 1/08; B04B 11/02; C02F 1/38; C02F 101/30

(52) U.S. Cl. CPC B04B 11/06; B01D 21/262; B04B 1/08; B04B 11/02; C02F 1/385; C02F 2101/30

(57) ABSTRACT

A centrifugal separator has a rotary bowl designed to purify a liquid-solid mixture containing sedimenting and floating solids from the solids in the centrifugal field during batch operation. The bowl includes a separating chamber, a liquid discharge which, when the batch is being processed, continuously discharges the purified liquid phase from the separating chamber, and at least two solids-collecting regions provided at different radii of the bowl, one of which is used to collect a first, lighter, floating solid phase, and the other one is used to collect a second, heavier, sedimenting solid phase, so that the solid-collecting regions can be filled with the relevant solid phase over time while the relevant batch is being processed.

### BACKGROUND AND SUMMARY OF THE INVENTION

Exemplary embodiments of the invention relate to a centrifugal separator and a process for purifying a liquid-solid mixture of solids with such a centrifugal separator.

Centrifugal separators are known from the prior art for a wide variety of separation tasks.

For example, DE 10 2005 021 331 A1 shows a three-phase separator and a method for three-phase separation with such a separator, in which a heavier liquid phase is discharged via an outlet to which a throttle device is assigned and a lighter liquid phase is discharged by means of a paring disk. The solids are discharged continuously via solids outlet nozzles.

DE 697 12 569 T2, on the other hand, discloses a purifier separator in which the lighter liquid phase is carried out by means of a paring disk and the other heavy liquid phase by means of an outlet element, which is pressed by a drive device to varying locations on a free liquid surface, so that this phase is also always discharged during operation, wherein the immersion depth in this phase should be kept constant if possible in order to reduce energy consumption.

All of these separators have proven themselves for specific separation tasks. However, they are not, or not very, suitable for purifying and separating a liquid-solid mixture into a medium-heavy liquid phase (e.g., water) and a relatively lighter first solid phase and second solid phase which is relatively heavier thereto. In a clarifier with water as the medium-heavy liquid phase, the relatively lighter solids of the first solid phase would float to the surface of the water and the relatively heavier solids of the second solid phase would sink to the bottom of the clarifier (sedimentation).

However, such simultaneous purification of a liquid-solid mixture of both floating and sedimenting solids is of interest for various separation tasks, such as the separation and classification of microplastics from water bodies or water. Microplastics are generally defined as plastic particles smaller than 5 mm in size. To date, centrifugal separators have only been used in isolated cases. There are also other technologies for the clarification process. These include cascade filtration or fractionated filtration (filters connected in series with decreasing pore size), a suspended solids trap or a sedimentation box (container with settling chambers arranged in a labyrinth), as well as centrifugal separators operating in batch mode. With the latter, however, only the sedimenting solids can be separated. DE 1 178 014 can be cited as an example of such a centrifugal separator operating in batch mode.

However, in order to detect the entire range of plastics (polymers) with different densities using centrifugal separation technology, it is necessary to detect both sedimenting and floating polymers.

Exemplary embodiments of the invention are directed to a centrifugal separator that is particularly suitable for purifying the liquid-solid mixture of floating solids and sedimenting solids. In addition, a suitable method for purifying the liquid-solid mixture of floating solids and sedimenting solids is to be created.

According to the invention, a separator with a rotatable bowl is provided, wherein the bowl is designed for purifying a liquid-solid mixture with sedimenting and floating solids from the solids in the centrifugal field during batch operation, so that the liquid-solid mixture can be separated into a liquid phase and a first lighter solid phase of floating solids and a second heavier solid phase of sedimenting solids, wherein the bowl has a separating chamber and a liquid discharge continuously discharging the purified liquid phase from the separating chamber during the processing of the batch, and at least two solids-collecting regions provided at different radii of the bowl, one of which is designed or serves to collect the first lighter solid phase and the other to collect the second heavier solid phase, wherein the solids-collecting regions can be filled with the relevant solid phase over time while the relevant batch is being processed.

Such a separator is particularly advantageous for purifying a product that contains at least one flowable phase with a first density (L and at least two solid phases with two different density classes [symbol] SI and [symbol] Sh. The two solid phases preferably contain plastic particles of different density classes [symbol] SI and [symbol] Sh and the following applies: [symbol] SI< [symbol] L< [symbol] Sh. The lighter solid phase and the heavier solid phase can in turn be composed of solids of different densities, which are only lighter or heavier than the liquid phase. The lighter solid phase, the liquid phase and the heavier liquid phase are separated from each other and collected separately.

According to a preferred advantageous further development, the bowl is designed in such a way that the liquid phase is discharged from the separating chamber on a central radius, the first solids-collecting region for the lighter solid phase is located on a smaller radius relative to the central radius and the second solids-collecting region for the heavier solid phase is located on a larger radius relative to the central radius. In this way, the solids of different densities can be advantageously collected radially further inwards and radially further outwards in the bowl during operation.

It is preferable and advantageous and supports the separation process if at least one means for increasing the equivalent clarifying surface is formed in the separating chamber.

The means for increasing the equivalent clarifying surface can be a disk pack or a ribbed insert with ribs that extend essentially radially, for example.

The central radius on which the continuous liquid discharge takes place can also be realized in various ways, for example with a separating disk or with one or more tubes whose inlet is located in the region of the central radius and through which the liquid is conducted out of the rotating bowl.

According to an advantageous further development, it may be provided that the bowl can be opened so that the solid phases can be removed from the bowl after a batch has been processed and when the bowl is stationary. For this purpose, it appears particularly useful if the bowl can be opened in a lower region, so that after processing a batch the solid phases and a residual liquid can run out of the bowl via a drain into a container.

The invention also provides a use of a separator according to the discussion above, for centrifugally clarifying a liquid-solid mixture comprising sedimenting and floating solids from the solids.

The invention also provides a method for centrifugally clarifying a liquid-solids mixture comprising sedimenting and floating solids from the solids in a separator according to one of the preceding claims, comprising the following steps:

### Step 100:

Providing the separator and a batch of the liquid-solid mixture with a medium-heavy liquid phase (L) and a lighter solid phase (SI) with floating solids and a heavier solid phase (Sh) with sedimenting solids,

### Step 200:

Rotating the bowl and feeding the bowl with the liquid-solid mixture so that centrifugal separation takes place within the separating chamber between the medium-heavy liquid phase and the lighter solid phase with the floating solids and the heavier solid phase with the sedimenting solids, so that the lighter solid phase is displaced into the center of the separating chamber by the medium-heavy liquid phase and the heavier solid phase flows into the region of the largest diameter on the inside of the bowl wall;

### Step 300:

Collecting the light floating solid phase in the center of the separating chamber in at least one first solids-collecting region in the center of the disk pack or in the center of the ribs and collecting the heavy sedimenting solid phase in a second solids-collecting region in the area of the largest diameter on the inside of the bowl wall; and

### Step 400:

Opening the bowl after processing the batch and discharging or removing the solids from the open bowl.

The solids can then be examined more closely or disposed of.

With the separator and the method according to the invention, it is possible in particular—but not exclusively—to discontinuously separate microplastics from water in batch or batching operation. This technical solution can also be used to purify water and wastewater from plastic and/or microplastics.

The specific density of the individual polymers present in microplastics varies greatly. Thus, in a mixture of water (reference approx. 1.0 g/cm³ for freshwater or 1.02 to 1.03 g/cm³ for seawater) and microplastics in the gravitational field, a distinction can be made between sedimenting microplastic particles (sinking in water) and floating microplastic particles (floating in water). Typical density ranges of exemplary plastic types are listed in the following table:
PE 0.917-0.965 g/cm³
PP 0.900-0.910 g/cm³
Fresh water approx. 1.0 g/cm³ (reference)
Seawater approx. 1.02 to 1.03 g/cm³ (reference)
PS 1.040-1.100 g/cm³
PA 1.020-1.050 g/cm³
PVC 1.160-1.580 g/cm³
PET 1.370-1.450 g/cm³

The separator according to the invention, with which the different polymers can be separated from the water samples, can very well separate both sedimenting (heavier than water) and floating (lighter than water) particles and collect them separately from each other.

For analysis, the water samples can be processed in batch or batching operation, wherein the separated particles remain in the centrifuge during the processing of the batch so that they can be quantitatively evaluated after the end of the batch processing. After manually removing the separated microplastics from the bowl, the separated amount of microplastics can be determined and compared to the volume of the water sample processed in the respective batch.

It should also be mentioned that the solid-liquid mixture can be pre-filtered with a coarse filter before being fed into the bowl in order to remove large solids. This is particularly useful if the means for increasing the equivalent clarifying surface is a disk pack.

### BRIEF DESCRIPTION OF THE DRAWING FIGURES

The invention is described in more detail below with reference to the drawings by means of an exemplary embodiment, wherein:

FIG. 1 shows a sectional view of a schematically depicted first bowl according to the invention with a hood;

FIG. 2 shows a sectional view of a schematically depicted second bowl according to the invention with a hood; and

FIG. 3 shows the separator from FIG. 1a in sectional view, supplemented by a solids outlet; and

FIG. 4 shows a side view of the separator from FIGS. 1 and 3.

### DETAILED DESCRIPTION

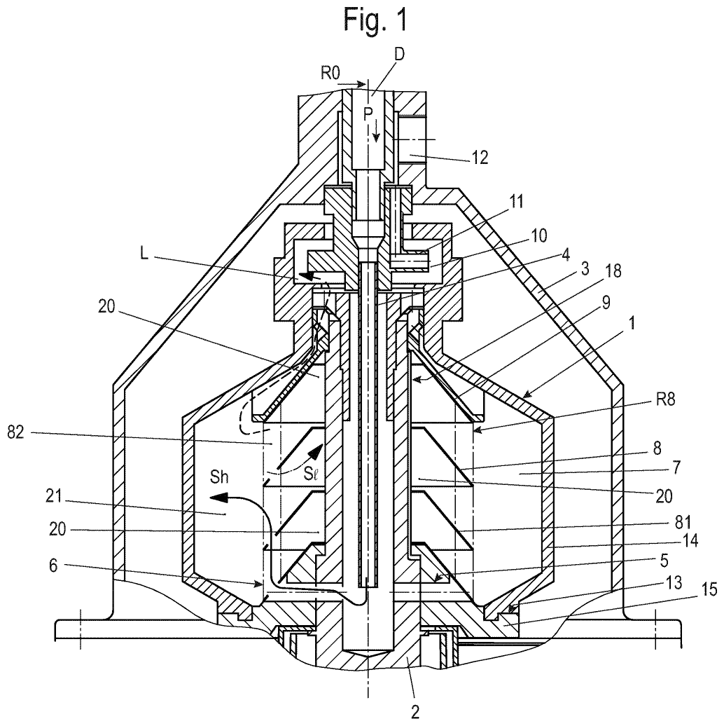

FIG. 1 shows a rotatable bowl 1, which has a full shell and preferably a vertically aligned axis of rotation D, which lies on a radius R0.

This bowl 1 is designed for purifying a liquid-solid mixture of solids, which contains at least one flowable phase of a first density [symbol] L and at least solids with two different density classes [symbol] SI and [symbol] Sh. The solids can essentially be polymer particles (rubber, plastic, polymers) of different densities [symbol] SI and [symbol] Sh. The following applies: [symbol] SI< [symbol] L< [symbol] Sh. The lighter solid phase SI and the heavier solid phase Sh can in turn be composed of solids of different densities, which have in common that they are respectively lighter and heavier than the liquid phase.

In the bowl, the liquid is purified in the centrifugal field by the two solid phases of different density classes [symbol] SI and [symbol] Sh in a batch operation—i.e., batch by batch. During the processing of a respective batch, the liquid phase is continuously discharged completely from the bowl until the end of the processing of the respective batch. The solid phases of different densities, on the other hand, are essentially collected on different radii in two different solids-collecting regions 20 and 21 within the bowl 1 and remain in these areas of the bowl 1 during the processing of the respective batch. During centrifugal processing, no solids can be discharged from the bowl with this bowl design.

In a further development of such a centrifuge, it is conceivable to empty the solids-collecting regions 20 and 21 at suitable intervals during operation (self-emptying centrifuge) in order to realize continuous clarification operation in this way.

The light solid phase SI essentially contains floating solids, as this phase is lighter than the liquid phase. The heavier solid phase Sh, on the other hand, contains sedimenting solids that are heavier than the liquid phase, wherein the floating solid phase SI and the sedimenting solid phase Sh can in turn be composed of solids of different densities. The liquid phase can be water, in particular the water of a body of water to be examined or purified. In addition to natural bodies of water such as rivers, lakes or seas, it can also be liquids from washing machines, PET recycling plants, washing lines or other waste water.

At the end of the processing of the respective batch, bowl 1 is opened and the solids are removed from bowl 1 and examined further or optionally disposed of.

To implement this, the bowl 1 of FIG. 1 is designed as follows:

The bowl 1 has a vertically aligned axis of rotation D on the radius R0.

The rotatable bowl 1 is mounted on a rotating spindle 2, which is driven by a drive motor, for example directly or via a belt. The rotating spindle 2 is mounted so that it can rotate accordingly.

The rotating spindle 2 can be of conical design in its upper and/or lower circumferential area. It also preferably has a central cylindrical section. The bowl 1 can be surrounded by a stationary hood 3 that does not rotate with the bowl.

The advantageously double-conical bowl 1 has a product feed pipe 4 for a product P to be centrifuged, to which a distributor 5 is connected, which is provided with at least one or more inlet openings 6, through which incoming centrifuged product is fed into the interior of the bowl 1 into the separating chamber 7. The feed can be fed into the bowl 1 axially from above or axially from below.

A device for increasing the equivalent clarifying surface is preferably provided in bowl 1. This can be realized in various ways.

According to FIG. 1, the device for enlarging the equivalent clarifying surface is realized by a disk stack 8 consisting of preferably conical separating disks 81. The separating disks 81 extend to a radius R8.

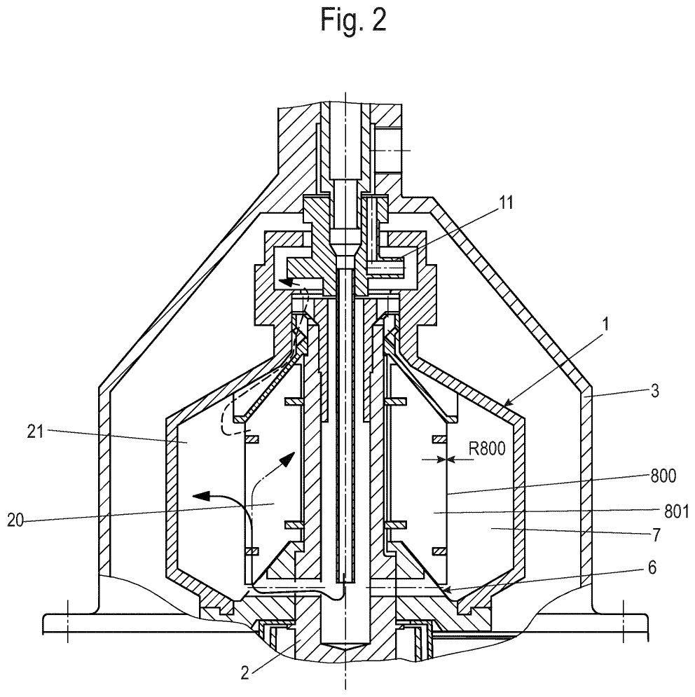

According to FIG. 2, however, the device for increasing the equivalent clarifying surface is realized by a ribbed insert 800 with preferably radial ribs 801, which are distributed circumferentially in the separating chamber 7. The ribs 801 extend to a radius R800.

The product feed pipe 4 is guided vertically into the bowl 1 from above. A feed line through the spindle, e.g., from below, is also conceivable (not shown).

According to FIG. 1, the design is such that the outlet openings 6 are located below a riser channel 82 in the disk stack 8 consisting of conically shaped separating disks 81.

In the separating chamber 7, the liquid-solid mixture is separated into a liquid phase L of medium density and a solid phase SI of relatively lighter, floating solids and a solid phase Sh of relatively heavier, sedimenting solids when the bowl 1 rotates fast enough as a result of the centrifugal forces.

To discharge the medium-density liquid phase, a device for discharging this liquid phase from the bowl is provided on a central radius in the separating chamber.

This device can be realized in various ways.

According to FIGS. 1 and 2, it is provided in each case that the device for discharging the liquid phase comprises a separating disk 9, the outer diameter of which is dimensioned such that it projects approximately radially centrally into the separating chamber 7.

Alternatively, one or more tubes with an inlet could protrude approximately radially into the center of the separating chamber 7 to discharge this phase and guide the liquid phase radially out of the bowl, similar to a nozzle separator. However, this variant would have a disadvantageously high energy consumption.

In FIGS. 1 and 2, the disk pack 8 is closed at the top by the conical separating disk 9, which here has a (slightly) larger diameter than the disk pack 8.

The liquid phase with the average density [symbol] L is fed via the separating disk 9 into a discharge chamber 10, which is equipped with the paring disk 11. The paring disk 11 directs the liquid phase L from the rotating system into a drain pipe 12 outside the bowl. In contrast to free discharge from the bowl (e.g., nozzle), part of the kinetic energy of the liquid can be converted into pump energy (centripetal pump) with the aid of the paring disk. Stable operating behavior in the separating chamber can also be achieved by setting a constant counterpressure at the outlet of the paring disk.

The bowl 1 therefore has no solids discharges with which the respective solid phase could be discharged during centrifugal processing of the batch. This discharge only takes place after the bowl 1 is stopped and the bowl 1 is opened.

This allows a liquid-solid mixture with sedimenting and floating solids to be processed centrifugally as follows in order to purify the liquid from solids:

### Step 100:

First, in a step 100, the separator is provided and the liquid-solid mixture is provided (preferably a batch).

### Step 200:

The bowl 1 is set in rotation and fed with the liquid-solid mixture. This is fed through/via the feed pipe 4 and the distributor 5 into the separating chamber 7. During operation, a centrifugal separation between the medium-heavy liquid phase L and the lighter solid phase SI with the floating solids and the heavier solid phase Sh with the sedimenting solids takes place within the separating chamber 7 when the bowl 1 rotates accordingly. In this way, the liquid phase L is clarified from the solid phases SI and Sh as bowl 1 rotates.

### Step 300:

The lightest substances—in this case the floating solids SI—are forced into the center of the separating chamber 7 by the medium-heavy liquid phase L in the centrifugal field. There is no outlet for them, so that these light solids collect in at least one first solids-collecting region 20—in the center of the separating chamber 7—e.g., around a centric shaft 18.

The heavy sedimenting solids Sh, on the other hand, flow outwards in the centrifugal field. There is no outlet for them either, so they are pressed into the area of the largest diameter in at least one second solids-collecting region 21 on the inner wall of the bowl 1 (here cylindrical on the inside in one section) and remain there.

In this process, the liquid phase L—preferably water from a body of water—is passed through the device for discharging the liquid phase from the bowl 1.

This means that only the liquid phase L leaves the bowl during processing of the batch, while the floating and sedimenting solids SI, Sh remain in the bowl.

### Step 400:

After the batch has been processed, the bowl 1 can be opened and the solids that have accumulated in the bowl 1, which have also been separated into at least two different density classes in the bowl 1, can be removed from the opened bowl 1. It can then be further examined or disposed of, for example.

The liquid-solid mixture is thus very advantageously clarified in batches in the solid bowl separator. A batch can be operated as long as the solids-collecting regions 20, 21 of the bowl allow, i.e., they are not yet filled. A check can be carried out, for example, by means of a sensor (not shown) at the end of the liquid phase. As soon as the sensor detects that a maximum permissible quantity of solids has been exceeded in the liquid phase, this means that one or both solids-collecting regions are full and cannot hold any more solids. Processing of the batch must then be stopped.

At the end of processing a batch, bowl 1 is stopped and opened. The solids SI, Sh can then be removed from it.

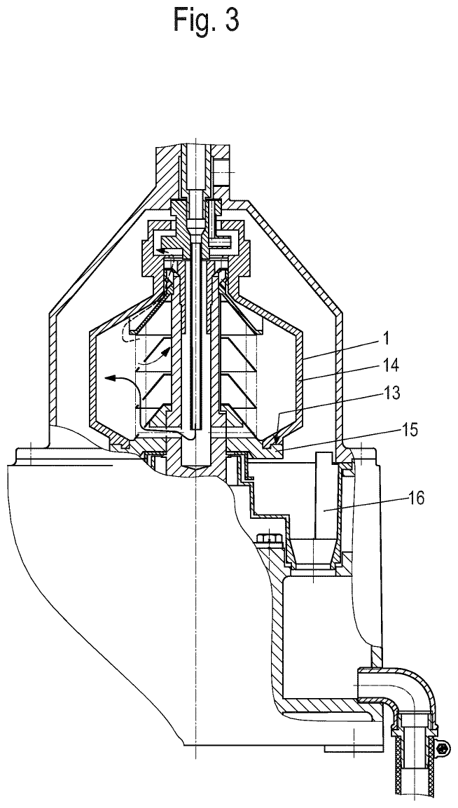

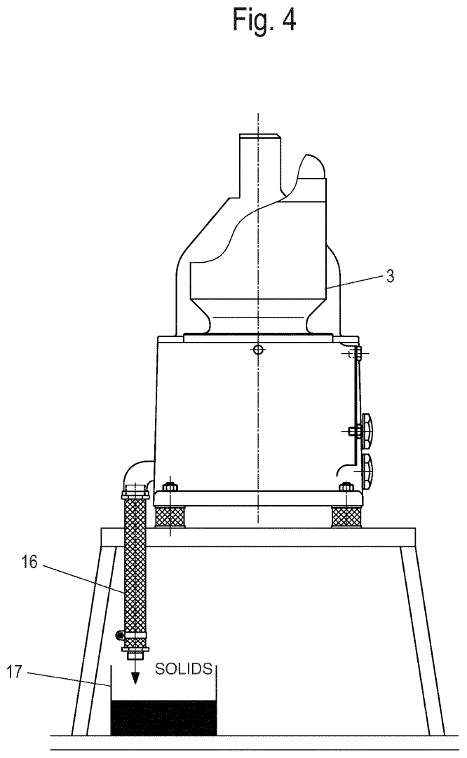

For this purpose, according to one embodiment, the bowl can be unscrewed at a separation point 13, preferably in the area of the base of the bowl 1, into an upper part 14 and a lower part 15, so that the separated particles—i.e., the two solid phases SI, Sh together—can flow out of the bowl together with any residual liquid remaining in the bowl 1 (see FIG. 3). This outflowing solid/liquid mixture is drained off via a drain 16 underneath the bowl and, as shown in FIG. 4, discharged into a container 17 where it is collected.

According to FIG. 2, the disk pack 8 is replaced by the preferably star-shaped ribbed insert 800 with circumferentially distributed, preferably radially aligned ribs 801. Although this embodiment has a smaller equivalent clarifying surface compared to the disk pack 8, it is more suitable for picking up solid particles of irregular size, in particular the risk of blockages that may occur in the disk pack is further reduced and pre-filtering can be avoided.

The particles remaining in the bowl 1 or on the wing insert or in the disk pack can then be emptied manually into the container 17.

Then, for example, the quantity of separated particles can be determined and compared with the volume of liquid (water, waste water, etc.) that was passed through the separator in this batch. Both the number of particles and the total weight of the separated particles can be evaluated as the “quantity”. This means that both the number of particles/liter and the particle weight/liter can be determined. The value for the particles is the sum of floating and sedimenting particles.

It is also conceivable to discharge and collect the sedimenting solids and the floating solids separately when carefully opening the bowl 1.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

Bowl 1
Rotating spindle 2
Hood 3
Product feed pipe 4
Distributor 5
Outlet opening 6
Separating chamber 7
Disk pack 8
Separating disk 81
Riser channel 82
Ribbed insert 800
Ribs 801
Separating disk 9
Discharge chamber 10
Paring disk 11
Drain pipe 12
Separation point 13
Upper part 14
Lower part 15
Drain 16
Container 17
Shaft 18
Solids-collecting regions 20, 21
Product P
Radius R0
Outer radius of separating disk R8
Outer radius ribs R800
Liquid phase L
Heavier solid phase Sh
Lighter solid phase SI
Axis of rotation D
Density [symbol] L
Density classes [symbol] SI, [symbol] Sh

1-14. (canceled)

15. A centrifugal separator, comprising:
a rotatable bowl configured to purify, into a purified liquid phase, a liquid-solid mixture containing sedimenting and floating solids by centrifugally separating the sedimenting and floating solids from the liquid-solid mixture in a centrifugal field during batch operation, wherein the bowl comprises
a separating chamber;
a liquid discharge configured to continuously discharge the purified liquid phase from the separating chamber during processing of the batch; and
at least two solids-collecting regions provided at different radii of the rotatable bowl, wherein a first of the at least two solids-collecting regions is configured to collect a first lighter floating solid phase and a second of the at least two solids-collecting regions is configured to collect a second heavier sedimenting solid phase so that the at least two solids-collecting regions are fillable with the respective solid phase over time while the batch is being processed.

16. The separator of claim 15, wherein the purified liquid phase is discharged from the separating chamber on a central radius and the first one of the at least two solids-collecting region for the lighter floating solid phase is located on a smaller radius relative to the central radius and the second one of the at least two solids-collecting region for the second heavier sedimenting solid phase is located on a larger radius relative to the central radius.

17. The separator of claim 15, further comprising:
at least one means for increasing an equivalent clarifying surface is arranged in the separating chamber.

18. The separator of claim 17, wherein the means for increasing the equivalent clarifying surface is a disk pack.

19. The separator of claim 17 wherein the means for increasing the equivalent clarifying surface is a ribbed insert.

20. The separator of claim 15, wherein the liquid discharge comprises a separating disk.

21. The separator of claim 16, wherein the liquid discharge comprises one or more tubes, an inlet of the one or more tubes is located in the region of the central radius and through which the liquid is conducted out of the rotating bowl.

22. The separator of claim 15, wherein the rotatable bowl, when stationary, is openable so that the first and second solid phases removable from the rotatable bowl after processing the batch.

23. The separator of claim 15, wherein the separator does not include a solids drain configured to discharge solids during centrifugal processing when the rotatable bowl rotates.

24. The separator of claim 23, wherein the rotatable bowl is openable in a lower region, so that after processing the batch of the two solid phases and a residual liquid is drainable out of the rotatable bowl via a drain into a container.

25. The separator of claim 15, further comprising:
a sensor arranged in the liquid discharge and configured to monitor a density of the discharged purified liquid phase.

26. A method for centrifugally purifying, into a purified liquid phase, a liquid-solid mixture comprising sedimenting and floating solids by centrifugally separating, by a centrifugal separator, from the sedimenting and floating solids from the liquid-liquid-solid mixture in a batch operation, the method comprising:
providing the centrifugal separator, which comprises a rotatable bowl configured to purify, into a purified liquid phase, the liquid-solid mixture containing sedimenting and floating solids from the liquid in a centrifugal field during batch operation, wherein the bowl comprises
a separating chamber;
a liquid discharge configured to continuously discharge the purified liquid phase from the separating chamber during processing of the batch; and
first and second solids-collecting regions provided at different radii of the rotatable bowl, wherein the first solids-collecting region is configured to collect a first lighter floating solid phase and the second solids-collecting region is configured to collect a second heavier sedimenting solids phase so that the first and second solids-collecting regions are fillable with the respective solid phase over time while the batch is being processed
rotating the rotatable bowl and feeding the rotatable bowl with the liquid-solid mixture so that centrifugal separation takes place within the separating chamber between the liquid phase and the first lighter floating solids phase and the second heavier sedimenting solid phase heavier solids phase so that the first lighter floating solids phase is displaced into a center of the separating chamber by the medium-heavy liquid phase and the second heavier sedimenting solids phase flows into a region of the largest diameter on the inside of the bowl wall;
collecting the light floating solid phase in the center of the separating chamber in at least the first solids-collecting region and collecting the heavy sedimenting solid phase in the second solids-collecting region in the region of the largest diameter on the inside of a bowl wall; and
opening the rotatable bowl after processing the batch and discharging or removing the light floating solids and the heavy sedimenting solids from the open rotatable.

27. The method of claim 26, wherein the light floating solids and the heavy sedimenting solids are plastic particles.
